(19) United States
(12) Patent Application Publication
(10) Pub. No.: US 2023/0335089 A1
(43) Pub. Date: Oct. 19, 2023

(54) OUTDOOR MUSICAL INSTRUMENTS HAVING SMARTPHONE-INTERACTIVE FEATURES AND SMARTPHONE STAND

(71) Applicant: PlayCore Wisconsin, Inc., Chattanooga, TN (US)

(72) Inventors: Luke Hayworth, Chattanooga, TN (US); Matthew Duff, Chattanooga, TN (US); Lindsay Hill, Chattanooga, TN (US); Kelly Ellington, Chattanooga, TN (US); Richard Cooke, Hesperus, CO (US)

(21) Appl. No.: 18/136,643

(22) Filed: Apr. 19, 2023

Related U.S. Application Data
(60) Provisional application No. 63/332,468, filed on Apr. 19, 2022.

(51) Int. Cl. G10H 1/00; G10H 1/32

(52) U.S. Cl. CPC G10H 1/0008; G10H 1/32; G10H 2230/015; G10H 2240/211

(57) ABSTRACT

An outdoor musical instrument, such as may be installed in a playground or other public outdoor recreational area, includes a machine-readable code. The code is readable by a mobile computing device, such as a smartphone or tablet, and, when read, furnishes the device with one or more interactive functions relating to the musical instrument and that provide enhanced play opportunities. The musical instrument may also include a stand configured for a user to place the device after reading the code in order to utilize the interactive functions while playing the instrument.

The present applications claims priority to U.S. Provisional Patent Application No. 63/332,468, filed on Apr. 19, 2022, the entirety of which is incorporated by reference herein.

### BACKGROUND

Research has shown that musical play is a key component of development in children. Music helps to build reasoning skills and cognitive development. It can increase the capacity of one's memory, refine time management and organizational skills, and teach perseverance. Playing music builds confidence, encourages creativity and self-expression. It can reduce anxiety, relieve symptoms of depression, and elevate one's mood. The Brain and Creativity Institute found that musical experiences in childhood can accelerate brain development, particularly in the areas of language acquisition and reading skills.

Research has also shown that being outside enhances a child's development. Nature is important to children's development in every major way—intellectually, emotionally, socially, spiritually and physically. Kellert, Stephen R., “Nature and Childhood Development”, In Building for Life: Designing and Understanding the Human-Nature Connection, Island Press, 2005. “Experience of the outdoors has the potential to confer a multitude of benefits on young people's physical development, emotional and mental health and well-being and societal development. Mental health and wellbeing benefits from play in natural settings appear to be long-term, realized in the form of emotional stability in young adulthood.” Travlou, Penny, “Wild Adventure Space For Young People”, OPENspace Individual Literature Reviews (2006).

As such, instruments placed in outdoor learning environments enable “children to explore natural sounds in the environment, make loud music, compose music individually and collaboratively, and move expressively.” Spencer, Karin H, et al., Quality Outdoor Play Spaces for Young Children, Young Children, pp 28-34 (2014).

### SUMMARY OF THE INVENTION

Embodiments of the present disclosure are directed to musical instruments that are configured to be installed in an outdoor environment, such as a playground or public recreational area. In contrast to existing outdoor instruments, however, embodiments of the present disclosure may work in conjunction with a mobile computing device such as a smartphone or tablet computer to provide additional interactive features, such as song sheets, games, training, background tracks, recording options, and the like. Embodiments of the present disclosure may also provide a stand which is designed and configured to hold the mobile computing device at a position and angle so that the user may view the screen of the device while playing the instrument and/or so that the camera of the device has a field of view that is conducive to video recording of the user playing the instrument.

Embodiments of the present disclosure are directed to musical instruments that are configured for installation in an outdoor environment, such as a playground or other public recreational area. The musical instruments include a plurality of tone-producing elements, such as resonating bars, tubes, plates, or the like, which may be struck by a mallet, keys which may be played with a user's hands/fingers, or drums, each of which is configured to produce a defined pitch when actuated by a user. Generally, the plurality of tone-producing elements may be supported by a frame and the frame may be supported at an elevated position relative to a ground surface by one or more support posts, the lower ends of which are configured for mounting to the ground surface in an outdoor environment. However, other structures for supporting the plurality of tone-producing elements are also contemplated without departing from the scope of the present disclosure.

In addition to the plurality of tone-producing elements and the supporting structure, the musical instruments of the present disclosure include a machine-readable code, e.g. a QR code, an NFC code, or the like, configured to be read by a mobile computing device such as a smartphone, tablet computer, or the like. When read by a mobile computing device, the machine-readable code may be configured to furnish the mobile computing device with one or more interactive functions relating to the musical instrument. The one or more interactive functions may access and make use of the screen, speaker, microphone, and/or camera/video recorder of the mobile computing device. The one or more interactive functions may include, for example, any of the following: (i) playing one or more musical backing tracks; (ii) providing one or more training features; (iii) providing one or more play challenges; (iv) displaying one or more song sheets or sequential notes for playing a song; (v) providing one or more recording features; or any combination thereof.

In some embodiments, for instance, when read by a mobile computing device, the machine-readable code may either cause a website or application (“app”) to open on the mobile computing device or cause the mobile computing device to prompt a user to open a website or application (“app”), the website or application containing the one or more interactive features. Where the website or application offers a plurality of interactive features, the website or application may then prompt a user to select from the plurality of interactive features.

Embodiments of the musical instrument of the present disclosure also include a stand that is configured to support a mobile computing device at a position and angle such that a screen of the computing device is visible to a user while the user actuates the one or more tone-producing elements, i.e. while the user plays the instrument. In this way, a user may use the mobile computing device, e.g. smartphone or tablet, to read the machine-readable code and rest the device on the music stand so that the screen of the device is easily visible while the user plays the instrument. This not only frees up both of the user's hands to play the instrument, but also places the screen of the device within a suitable field of vision to enable the user to easily view the device while playing the instrument. As an example, one or more of the interactive features may utilize the screen to identify one or more of the plurality of tone-producing elements to be actuated at a given time and/or in a given sequence.

The stand may be affixed to the support structure of the musical instrument. For instance, the stand may be affixed to the frame that supports the plurality of tone producing elements or at least one of the one or more support posts. In other embodiments, the stand may not be affixed to the support structure of the musical instrument but rather separately mounted to the outdoor ground surface at a position adjacent to the musical instrument.

In some embodiments, the stand may be configured to place the mobile computing device, e.g. smartphone or tablet, at a desirable orientation for viewing the screen while playing the musical instrument. For instance, the stand may be configured to support a mobile computing device at an angle between about 55 and 75 degrees, alternatively between about 60 and 70 degrees, alternatively about 65 degrees relative to a ground surface on which the musical instrument is mounted.

In order to support the mobile computing device at a desirable orientation for viewing the screen while playing the musical instrument, the stand may include a ledge and a device support wall. In some embodiments, the device support wall may be configured to support a mobile computing device, e.g. smartphone or tablet, at an angle between about 55 and 75 degrees, alternatively between about 60 and 70 degrees, alternatively about 65 degrees relative to a ground surface on which the musical instrument is mounted. In some embodiments, for instance, the device support wall may be oriented at an angle between about 25 and 45 degrees with the mounting plate and/or frame of the instrument (which itself may typically be angled relative to the ground surface). Given that the musical instrument is configured and intended to be mounted in an outdoor environment, at least one of the ledge and the device support wall may include one or more apertures or channels configured to drain water from the ledge, so as to ensure that water, e.g. from rain, is diverted away from the location on which it is intended that a user position the mobile computing device, e.g. smartphone or tablet.

The stand may also include a mounting plate that is affixed to a portion of the support structure of the musical instrument. In some embodiments, for example, the mounting plate may be affixed to the frame of the musical instrument. In other embodiments, the music stand may further include a frame extension element. In such an embodiment, the frame extension element may be affixed to another part of the musical instrument, e.g. the frame, one or more resonators, etc., and the mounting plate may then be affixed to the frame extension element. This embodiment may be particularly useful, for example, where the stand is mounted to a pre-existing musical instrument design and the support structure of the pre-existing musical instrument does not have a suitable surface to which a mounting plate of the stand can be attached. The frame extension element may include one or more contours that prevent interference between the stand and one or more of the plurality of tone producing elements, one or more resonators, or a combination thereof.

In some embodiments, the machine-readable code may comprise a visual code, such as a QR code or the like, that is configured to be read using a camera element of the mobile computing device. In such an embodiment, the machine-readable code should be visible to a user, i.e. positioned on an exterior surface of the musical instrument. Because the front face of the stand will be readily visible to a user when playing the musical instrument, the machine-readable code may be positioned on the front face of the stand. In some embodiments, for example, the front face of the music stand may be defined, at least in part, by a metal plate, and the machine-readable code may be either (a) printed or etched on the metal plate or (b) adhered to the metal plate.

In other embodiments, the machine-readable code may comprise a tag, such as a NFC tag or the like, that is configured to be read by placing the mobile computing device into proximity with the tag. In such an embodiment, the tag should be placed in a location on or within the musical instrument where a user would easily be able to tap his or her mobile computing device, e.g. smartphone, and the presence/location of the tag should be visually indicated to a user. Because the stand is configured to support the mobile computing device, the machine-readable code, here a tag, may be incorporated into the stand. In order to ensure that the tag is suitable to withstand the outdoor environment, the tag itself may not be on the front surface of the stand but may instead be protected from the outdoor environment, e.g. recessed and/or covered. In such an embodiment, however, the front surface of the stand may include a visual indication that a user should tap or place a mobile computing device on the stand in order to activate the interactive functions.

The stand may also be configured to support a physical song book or song sheet. In some embodiments, the musical instrument may include a weather-resistant song book or song sheet attached to either the stand or the support structure of the musical instrument, e.g. the frame or at least one of the one or more support posts. The weather-resistant song book or sheet may be attached to the stand or the support structure by a cable or the like. The weather-resistant song book or sheet may comprise one or more pages made of a weather-resistant material, e.g. plastic.

In any embodiment of the present disclosure, the plurality of tone-producing elements, the support structure, the machine-readable code, and the stand may all be configured to withstand the stresses of being installed in an outdoor environment.

Although the description is predominantly directed to musical instruments that are specially configured for installation and/or use in an outdoor environment, the installation and/or use of any of the embodiments described herein in an indoor or indoor/outdoor location is contemplated without departing from the scope of the present disclosure. Similarly, although the description is predominantly directed to musical instruments that are specially configured for installation and/or use in an outdoor environment, the incorporation of a machine-readable code and/or a stand configured to place a mobile computing device, e.g. smartphone or tablet, at a desirable orientation for viewing the screen while playing the musical instrument into a musical instrument that is designed and configured for indoor use, e.g. in any of the manners described herein, is also contemplated without departing from the scope of the present disclosure.

Another aspect of the present disclosure is directed to a method of operating the musical instruments described herein. The method includes (a) using a mobile computing device to read the machine-readable code that is present on the musical instrument, (b) selecting an interactive feature using the mobile computing device, and (c) actuating one or more of the of tone-producing elements in response to an output of the mobile computing device, i.e. using the selected interactive feature while playing the musical instrument.

### BRIEF DESCRIPTION OF THE DRAWINGS

A clear conception of the advantages and features of one or more embodiments will become more readily apparent by reference to the exemplary, and therefore non-limiting, embodiments illustrated in the drawings:

FIG. 1 is a perspective view of a first embodiment of a musical instrument having a code that is readable by a mobile computing device and an integrated music stand that is configured to support the mobile computing device during operation of the musical instrument.

FIG. 2 is a front perspective view of the music stand of the embodiment illustrated in FIG. 1.

FIG. 3 is an exploded, perspective view of the music stand of the embodiment illustrated in FIG. 1.

FIG. 4 is a perspective view of a main body of the music stand of the embodiment illustrated in FIG. 1.

FIG. 5 is a side plan view of the main body illustrated in FIG. 4.

FIG. 6 is a perspective view of a frame extension element of the music stand of the embodiment illustrated in FIG. 1.

FIG. 7 is a perspective view of a second embodiment of a musical instrument having a code that is readable by a mobile computing device and an integrated music stand that is configured to support the mobile computing device during operation of the musical instrument.

FIG. 8 is a perspective view of a third embodiment of a musical instrument having a code that is readable by a mobile computing device and an integrated music stand that is configured to support the mobile computing device during operation of the musical instrument.

FIG. 9 is a front perspective view of a fourth embodiment of a musical instrument having a code that is readable by a mobile computing device and an integrated music stand that is configured to support the mobile computing device during operation of the musical instrument.

FIG. 10 is a rear perspective view of the embodiment illustrated in FIG. 9.

FIG. 11 is a front perspective view of a fifth embodiment of a musical instrument having a code that is readable by a mobile computing device and an integrated music stand that is configured to support the mobile computing device during operation of the musical instrument.

FIG. 12 is a rear perspective view of the embodiment illustrated in FIG. 11.

### DETAILED DESCRIPTION OF THE INVENTION

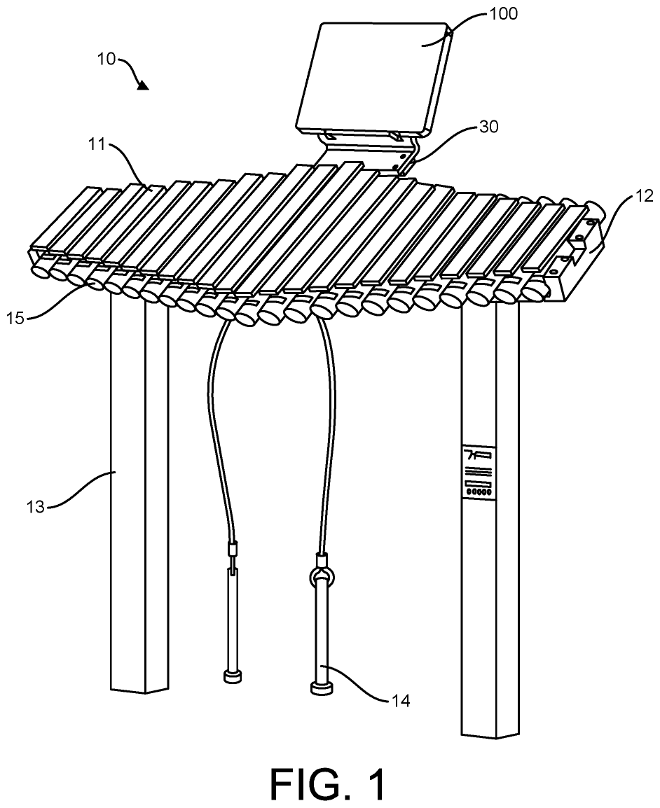

Embodiments of the present disclosure are directed to an outdoor musical instrument 10, an embodiment of which is shown in FIG. 1.

The musical instrument 10 shown in FIG. 1 includes a plurality of tone-producing elements 11, each of which is configured to produce a note having a defined pitch when struck with a mallet 14. In the illustrated embodiment, each tone-producing element 11 is a metal bar, more specifically an anodized aluminum bar, with the plurality of metal bars being configured to produce notes on one or more musical scales. As such, the musical instrument 10 shown in FIG. 1 falls within the class of instruments generally referred to as metallophones. In other embodiments, the musical instrument 10 may be a xylophone, marimba, chime-based instrument, or metal plate-based instrument, all of which may similarly be played using one or more hand-held mallets 14. In yet other embodiments, the musical instrument 10 may comprise a plurality of tone-producing elements 11 that each produce a note on one or more musical scales and which may be played directly by a user's hands or fingers. In still further embodiments, the musical instrument 10 may be a drum that can be struck in different areas to produce one or more tones, e.g. a metal tongue or steelpan drum, or set of drums, each of the set of drums being configured to produce one or more tones when struck.

In the embodiment illustrated in FIG. 1, the plurality of tone-producing elements 11 are supported by, and mounted to, a frame 12. The frame 12 may take on any of a variety of designs, so long as it supports the plurality of tone-producing elements 11. In the illustrated embodiment, for example, the frame 12 spans beneath the plurality of metal bars between a left side and a right side of the instrument. In other embodiments, for example, the frame 12 may surround or enclose the plurality of tone-producing elements 11. The design of the frame 12 may depend, at least in part, on the identity and layout of the tone-producing elements 11. For instance, the frame 12 of a metal tongue drum or a set of bongo drums will differ significantly in design from the frame shown in the illustrated embodiment. In some embodiments, a drum or drums may even be mounted directly to one or more support posts 13, and the frame 12 eliminated altogether.

The frame 12 may be made of any material that is able to withstand the stresses placed on it by user and the outdoor environment in which the musical instrument 10 is mounted. In the illustrated embodiment, for example, the frame 12 is made of high density polyethylene (HDPE), though other durable plastics could also be used.

The frame 12 is supported in an elevated position relative to a ground surface by support posts 13. In the illustrated embodiment, an underside of the frame 12 is coupled to an upper end of each of first and second support posts 13 through conventional means. In other embodiments, for example where there may be fewer metal plates, a single support post 13 may provide the musical instrument 10 with sufficient stability. On the other hand, where the instrument has a larger footprint, greater than two support posts 13 may be needed.

A lower end of each support post 13 may be configured for mounting to the ground surface in an outdoor environment.

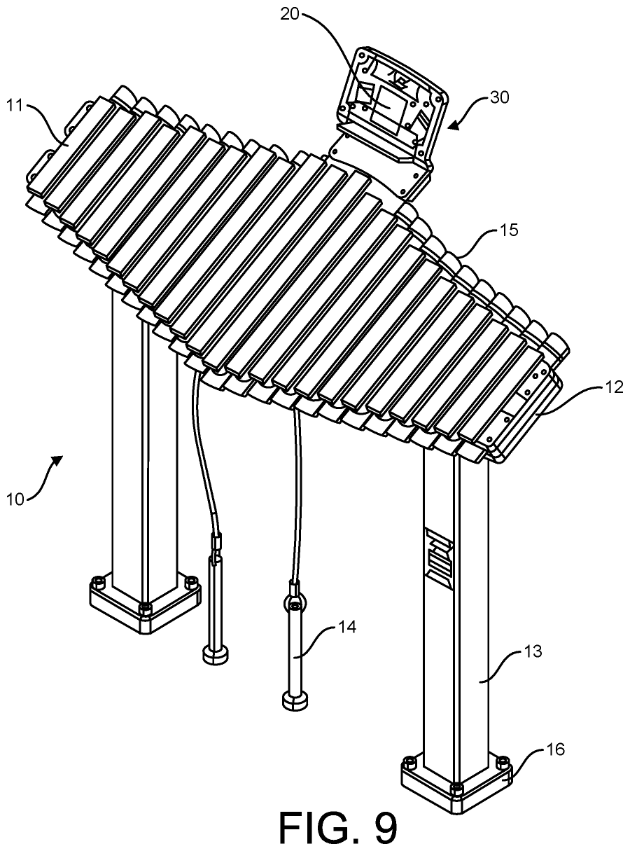

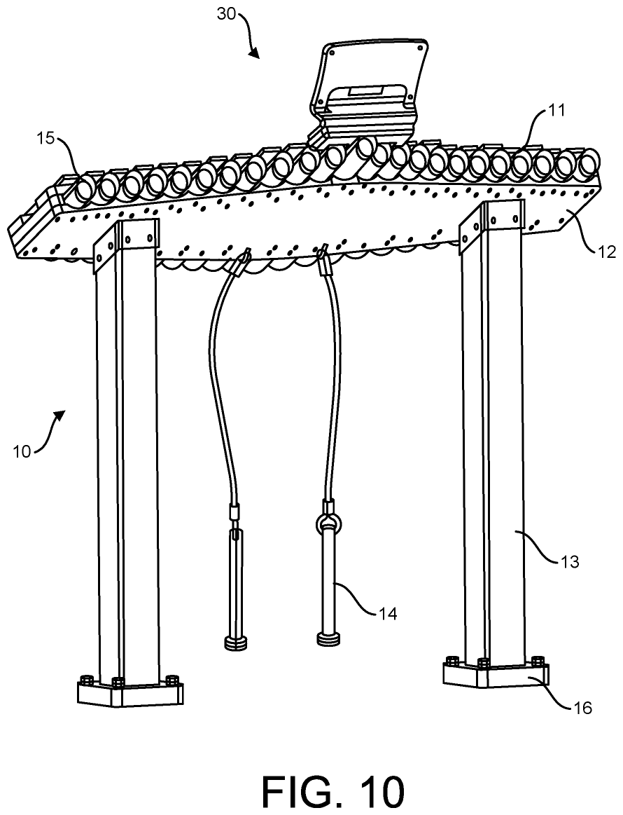

In some embodiments, the support posts 13 may be configured to be permanently, i.e. non-removably, installed to the ground surface. This may be accomplished in a number of ways. In some embodiments, an example of which is shown in FIGS. 9-10, the lower end of each support post 13 may comprise a base plate 16 that can be mounted directly to an outdoor surface using one or more fasteners. More specifically, one or more fasteners may be inserted through one or more apertures in the base plate 16 and directly into a ground surface, such as a concrete or other artificial surface material. Accordingly, the one or more fasteners may comprise one or more concrete (e.g. expansion) anchors, concrete screws, or the like.

In other (non-illustrated) embodiments, a base plate 16 at the lower end of each support post 13 may be affixed to an in-ground post that extends some distance below ground, e.g. by again passing one or more fasteners through the apertures in the base plate and apertures in a corresponding flange of the in-ground post. In yet other embodiments, each support post 13 may itself comprise an in-ground post configured to be inserted below the ground surface, such as into a hole. Once inserted into the hole, concrete may be poured around the in-ground post to secure the instrument 10 in an upright position.

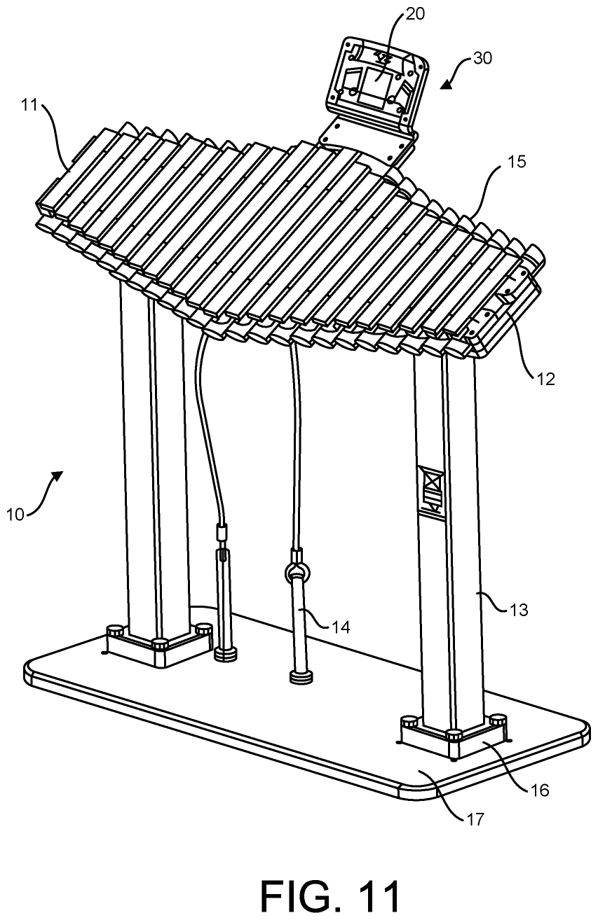

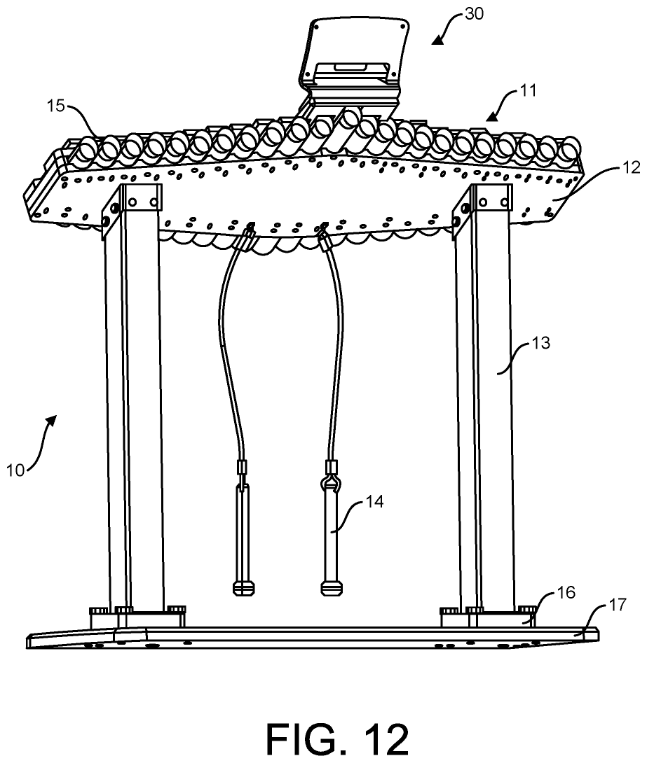

In other embodiments, the support posts 13 may be configured to be non-permanently, i.e. movably, mounted in an outdoor environment. In some embodiments, for instance, the lower end of each support post 13 may be coupled to a portable stand 17, an example of which is shown in FIGS. 11-12. The portable stand 17 may have a relatively large footprint, which may in some cases be similar to that of the musical instrument 10, in order to ensure stability of the instrument. The portable stand 17 may also be configured to withstand prolonged exposure to the outdoor environment. In some embodiments, the portable stand 17 may comprise a plurality of apertures configured to receive one or more fasteners, by which base plate(s) 16 of the one or more support posts 13 and the portable stand 17 may be affixed together.

The support post(s) 13 may be made from any of a variety of materials, so long as they have the necessary strength and weather resistance to stand up to prolonged outdoor environmental exposure and use. In some embodiments, each support post 13 may comprise stainless steel or powder-coated steel pipe. The powder coating serves to protect the steel against corrosion and other environmental degradation. As an alternative to powder coating, the steel pipe may be galvanized.

In some embodiments, the musical instrument 10 may also comprise one or more mallets 14. The one or more mallets 14 may have a head, e.g. a rubber head, of a durometer that is configured to produce a desired sound when used to strike the elements 11. The one or more mallets may be attached to the instrument, e.g. to a portion of the frame 12, the one or more support posts 13, or the like, by one or more cables. The term cable, as used herein, is intended to comprise any flexible element by which a mallet may be suspended and yet allows a user to use the mallet to strike the elements 11, and includes for example chains, ropes, cords, and the like. For instance the musical instrument 10 shown in FIG. 1 includes a pair of mallets 14, each of which is affixed to the frame 12 by a flexible cable. In other embodiments, the one or more mallets 14 may be attached by one or more cables to a separate mallet-support structure that is configured to be installed adjacent to the musical instrument 10. In some embodiments, the instrument 10, e.g. the frame 12, may comprise a docking station with one or more apertures configured to releasably receive the one or more mallets 14.

In some embodiments, the musical instrument 10 may also include one or more, and optionally a plurality of, resonators 15. In the embodiment illustrated in FIG. 1, for instance, a resonator tube 15 is positioned directly below each tone-producing bar 11. In this manner, the sound produced when a user strikes the tone-producing bar 11 with a mallet 14 is amplified by the associated resonator tube 15, producing a full and rich sound that sustains for a sustained period of time. Other embodiments of the musical instruments 10 described herein, including other embodiments of metallophones, may however not contain any such resonators 15.

The musical instruments 10 of the present disclosure further include a machine-readable code 20, which is visible on the exterior of the musical instrument and which may be read by a camera-bearing, mobile computing device 100 such as a smartphone or tablet. When read, the machine-readable code 20 causes the computing device 100 to open (or prompts the user to open) a website or mobile application, i.e. “app,” by which one or more interactive functions relating to the musical instrument 10 may be selected and utilized to increase the user's enjoyment of the instrument.

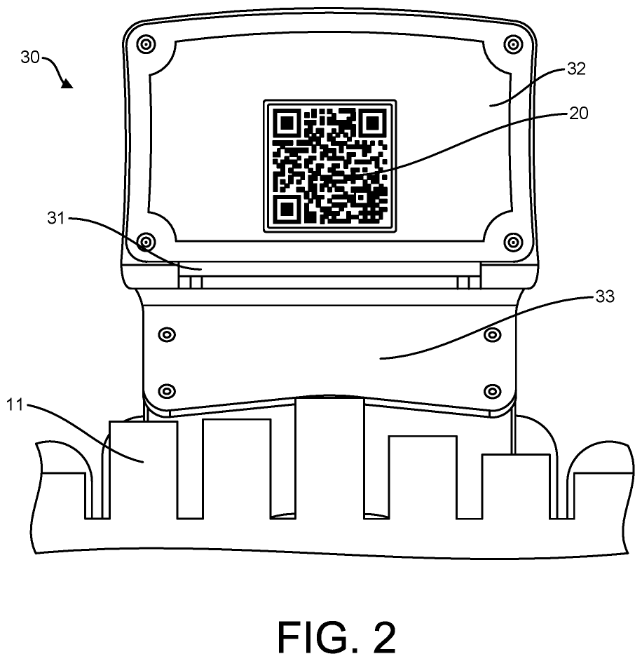

The machine-readable code 20 may be attached to any suitable exterior surface of the musical instrument 10. In some (non-illustrated) embodiments, for example, the machine-readable code may be present on a portion of the frame 12 or a support post 13. In the embodiment shown in FIG. 1, the machine-readable code 20 is present on an associated mobile computing device stand 30, the details of which are shown in FIGS. 2-6. In FIG. 1, the musical instrument 10 is shown with a mobile computing device 100—there a tablet computer—positioned on the stand 30, and thereby concealing the machine-readable code 20. The machine-readable code 20 may be seen, however, in FIG. 2 for instance.

The machine-readable code 20 may be a QR code, as shown in the illustrated embodiments, or may be any other type of code, e.g. a SnapTag, that can be scanned by the camera of a mobile computing device, such as a smartphone or tablet computer, and configured to cause the mobile computing device to either access a website or application or prompt a user to access a website or application that contains one or more interactive features.

In other, nonillustrated embodiments, the machine-readable code 20 may comprise a Near Field Communication (NFC) code, which may comprise an NFC tag that is readable by an NFC-enabled mobile computing device 100 (which includes conventional smartphones and tablet computers). As opposed to utilizing the camera element of a mobile computing device, e.g. smartphone, a user may read an NFC code by simply placing the mobile computing device into close proximity of the NFC code, sometimes known as “tapping”. As with scanning of a QR code, reading of an NFC code may cause the mobile computing device to either access a website or application or prompt a user to access a website or application containing one or more interactive features. As sample alternatives, a Radio Frequency Identification (RFID) tag, Bluetooth beacon, or the like could be utilized in much the same way.

The interactive functions may be designed and configured so that the smartphone or other mobile computing device provides output that enhances a user's play experience with the musical instrument 10. For instance, reading the machine-readable code 20, such as by scanning the QR code in the illustrated embodiment, may cause a website or application to open. That website or application may furnish the user with one or more interactive, instrument-related features; and desirably a plurality of interactive, instrument-related features from which to select.

In some embodiments, the interactive, instrument-related features may include one or more song sheets. When this feature is selected, the mobile computing device may suggest a note, a combination of notes (e.g. a chord), and/or a sequence of notes for the user to play on the instrument to create a song. This may be done, for example, by visually displaying the suggested note or notes, an image of the instrument showing which element or elements to activate to produce the suggested note or notes, or both. In some embodiments, this feature may also play the song on an integrated speaker of the mobile computing device before and/or while displaying the suggested note or notes for the user to play on the instrument. In some embodiments, the mobile computing device may record the user's playing of the instrument using audio recording, video recording, or both. In some embodiments, the mobile computing device may further be configured to analyze the recording of the user's playing of the instrument and optionally provide positive feedback. In some embodiments, the mobile computing device may suggest one or more new songs based, at least in part, on its analysis of the recording.

In some embodiments, the interactive, instrument-related features may include one or more backing tracks. When this feature is selected, the mobile computing device may play, from an integrated speaker of the mobile computing device, a musical tune or back-beat over which a user is invited to play the instrument. The musical tune or back-beat may act as a metronome to assist a user in keeping a beat. In some embodiments, the feature may also suggest a note, a combination of notes (e.g. a chord), and/or or a sequence of notes for the user to play on the instrument in relation with the backing track. This may be done, for example, by visually displaying the suggested note or notes, an image of the instrument showing which element or elements to activate to produce the suggested note or notes, or both. In some embodiments, the mobile computing device may record the user's playing of the instrument over the backing track using audio recording, video recording, or both. In some embodiments, the mobile computing device may further be configured to analyze the user's playing of the instrument and optionally provide positive feedback. In some embodiments, the mobile computing device may suggest one or more new songs and/or backing tracks based, at least in part, on its analysis of the recording.

In some embodiments, the interactive, instrument-related features may include one or more play challenges. In some embodiments, the play challenges may include speed or dexterity drills. When this feature is selected, the mobile computing device may (i) emit, from an integrated speaker of the mobile computing device, a series of notes for the user to repeat in a defined time period, (ii) display, on the screen of the mobile computing device, a series of notes, elements to activate, or both for the user to repeat in a defined time period, or both. The mobile computing device may then provide a timer (visually, audibly, or both) during which the user is intended to play the notes. In some embodiments, the mobile computing device may record the user's playing of the instrument using audio recording, video recording, or both. The mobile computing device may further analyze the recording of the user's playing of the instrument, and provide feedback, e.g. an indication of whether or not the user has played the proper sequence of notes within the allotted time. In some embodiments, the mobile computing device may learn from the its analysis of the recording, and may for instance suggest one or more new speed or dexterity drills based, at least in part, on its analysis of the recording.

In some embodiments, the interactive, instrument-related features may include one or more recording features by which the mobile computing device may record the user playing the instrument using audio recording, video recording, or both. In some embodiments, the mobile computing device may also be configured to edit the video, e.g. to incorporate cartoons or other graphics into the video during or after recording. This editing may be performed automatically by the website or application or manually by the user. In some embodiments, the device stand 30 may be consistently located on the instruments and configured to hold the mobile computing device 100 at a desired location and angle to record video of the user playing the instrument, simplifying the incorporation of various graphical elements at specific locations of the video.

In some embodiments, the interactive, instrument-related features may include one or more training tools, e.g. videos, tutorials, practice drills, and the like which may assist a user in learning how to play the instrument or different ways to play the instrument.

In some embodiments, a user may be prompted to input what type of mobile computing device is being used, e.g. tablet, smartphone, etc., and certain features, e.g. video features, may be optimized based on the user's input.

In some embodiments, the musical note emitted by each of the plurality of tone-producing elements may be visually provided to a user on the musical instrument, for instance on each of the tone-producing elements or near, e.g. adjacent to, each of the tone-producing elements. For example, a musical note (e.g. A, B, C, D, E, F, G, and optionally sharp or flat) may be printed and/or etched onto the tone-producing element or onto the frame in the vicinity of the tone-producing element. In some embodiments, scale intervals may also be visually provided to a user on the musical instrument, for instance on the frame in the vicinity of the tone-producing elements. These visual indicators may be referenced by a user when interacting with one or more of the interactive, instrument-related features.

In some embodiments, the tone-producing elements may be provided with defined colors and one or more of the interactive, instrument-related features may utilize that color-coordination to assist a user. For example, the visual display of the mobile computing device may show the color(s) of the tone-producing element(s) of the musical instrument during one or more of the interactive, instrument-related features.

In some embodiments, the musical instrument 10 may further include a device stand 30 which is configured to support the mobile computing device 100 at a position and angle such that a screen of the mobile computing device is visible to a user while the user plays the musical instrument. In some embodiments, the device stand 30 may also be configured to support the mobile computing device 100 at a position and angle such that a camera of the mobile-computing device has a field of view that includes the plurality of tone-producing elements 11 and/or the user's face while the user plays the instrument 10, thereby enabling photography and/or video recording of the user playing the instrument. In some embodiments, for instance, the device stand 30 may be configured to support a mobile computing device, e.g. smartphone or tablet, at an angle between about 55 and 75 degrees, alternatively between about 60 and 70 degrees, alternatively about 65 degrees relative to a ground surface on which the musical instrument 10 is mounted.

In some embodiments, the device stand 30 may also be configured to support a physical song sheet or book 50, e.g. a weather-resistant song book that is attached to the musical instrument 10 by one or more cables.

In some embodiments, the device stand 30 may be affixed to another part of the musical instrument 10. For example, the device stand 30 may be affixed to the frame 12, at least one of the resonators 15, or to at least one of the one or more support posts 13. In this way, the device stand 30 may be added to already-existing and even already-installed outdoor musical instruments 10. In other embodiments, the device stand 30 may be an integral part of the musical instrument 10. For example, the device stand 30 may an integral part of the frame 12 of the musical instrument. In yet other embodiments, the device stand 30 may be an independent component that is itself configured to be mounted to a ground surface in an outdoor environment, e.g. adjacent to the musical instrument 10. For instance, the device stand 30 may itself comprise one or more support posts that are configured for mounting to the ground surface, e.g. in any of the same ways as support post(s) 13 described above. In the embodiments illustrated in FIG. 1, the device stand 30 is coupled to the frame 12 of the musical instrument 10.

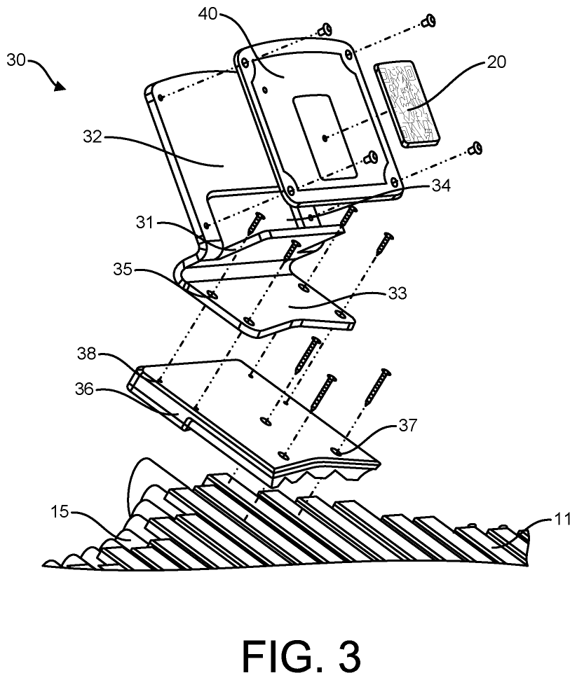

An embodiment of a device stand 30 is shown in FIGS. 2-3. In the illustrated embodiment, the device stand 30 includes a ledge 31 and a device support wall 32. The ledge 31 and the support wall 32 are configured to together support a mobile computing device 100, including for example a conventional smartphone or tablet, in a position and angle such that a screen of the mobile computing device is visible to a user while the user actuates the one or more tone-producing elements. The ledge 31 and the support wall 32 are also configured to together support a mobile computing device 100, including for example a conventional smartphone or tablet, at a position and angle in which a camera of the mobile-computing device has a field of view that includes at least the user's face and arm movements while the user plays the instrument 10, thereby enabling photography and/or video recording of the user playing the instrument.

More particularly, the device stand 30 shown in FIGS. 2-3 is configured so that an edge of a mobile computing device 100 will be supported by ledge 31 and a rear face of the mobile computing device will rest against the support wall 32. In FIG. 1, an example mobile computing device 100, specifically a tablet computer, is shown supported by the stand 30 in this manner.

As shown in the illustrated embodiment, the ledge 31 and support wall 32 may form an angle of about 90°, although other angles may also be used without departing from the scope of the present disclosure. Rather, the ledge 31 and support wall 32 should be positioned into order to stably support the mobile computing device 100, e.g. in a manner such that the device does not slide off of the ledge under the effects of gravity or in response to a slight jostling. But the specific angle of the ledge 31 and the support wall 32 may be selected to provide the mobile computing device 100 at a desired angle for viewing by a user while playing the musical instrument 100 and/or at a desired angle for a camera component of the device to capture a desired field of view.

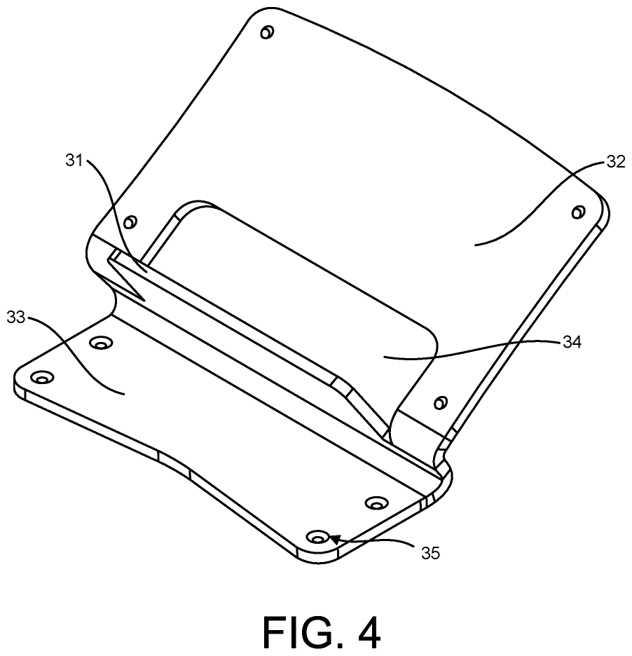

In the illustrated embodiment, the ledge 31 and support wall 32 are integral with one another, indeed they are part of an integral body that also includes a mounting plate 33. A detailed view of the integral body that comprises the ledge 31, support wall 32, and mounting plate 33 utilized in the device stand 30 illustrated in FIGS. 1-3 is shown in FIG. 4. However, it is also contemplated that any (or all) of the ledge 31, the support wall 32, and/or the mounting plate 33 may be a separate element, with the separate elements coupled together to form the device stand 30.

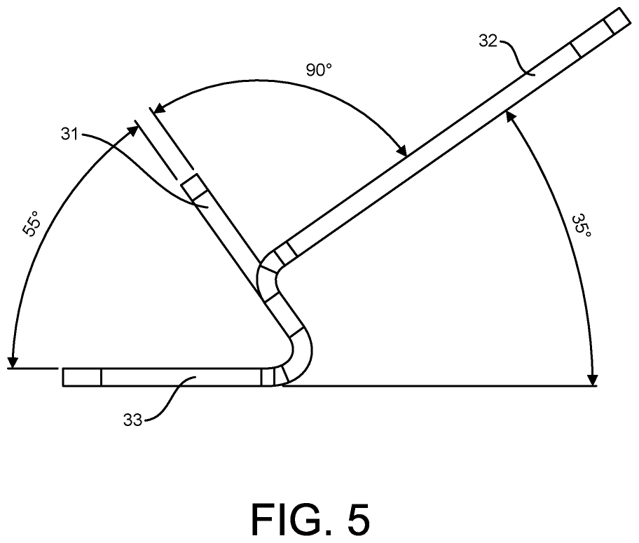

The positioning, and most significantly the orientation (e.g. angle) of the mobile computing device 100 may also be impacted by the angle formed between the device support wall 32 and the frame 12, or in the case of a device stand 30 that includes a mounting plate 33, by the angle formed between the device support wall and the mounting plate. In some embodiments, this angle may be between about 15° and about 55°, alternatively between about 20° and about 50°, alternatively between about 25° and about 45°. In the illustrated embodiment, for example, the angle formed between the support wall 32 and the mounting plate 33 is about 35°, as shown in FIG. 5. In some embodiments the frame 12 may be angled other than perpendicular with respect to the ground surface in order to place the plurality of tone-producing elements 11 at a desirable angle for striking as part of a play activity. In the illustrated embodiments, for example, the frame 12 and tone-producing elements 11 are positioned at an angle of about 30 degrees relative to the ground surface, although other angles are also contemplated, e.g. between about 15 degrees and about 45 degrees relative to the ground surface, alternatively between about 20 degrees and about 40 degrees relative to the ground surface, alternatively between about 25 and about 35 degrees relative to the ground surface. Where the frame 12 is angled as such with respect to a ground surface on which the musical instrument is mounted, and the device support wall 32 is provided at a desired angle relative to the frame 12, the device stand 30 may thus be configured to support a mobile computing device, e.g. smartphone or tablet, at a desired angle between about 55 and 75 degrees, alternatively between about 60 and 70 degrees, alternatively about 65 degrees relative to the ground surface.

Similarly, the positioning, and most significantly the orientation (e.g. angle) of the mobile computing device 100 may also be impacted by the angle formed between the ledge 31 and the frame 12, or in the case of a device stand 30 that includes a mounting plate 33, by the angle formed between the ledge and the mounting plate. In some embodiments, this angle may be between about 35° and about 75°, alternatively between about 40° and about 70°, alternatively between about 45° and about 65°. In the illustrated embodiment, for example, the angle formed between the ledge 31 and the mounting plate 33 is about 55°, as shown in FIG. 5. Where the frame 12 is angled with respect to a ground surface on which the musical instrument is mounted (as described above), and the ledge 31 is provided at a desired angle relative to the frame 12, the device stand 30 may thus be configured to support a mobile computing device, e.g. smartphone or tablet, at a desired angle between about 55 and 75 degrees, alternatively between about 60 and 70 degrees, alternatively about 65 degrees relative to the ground surface.

At least one of the ledge 31 and the device support wall 32 may include one or more apertures or channels configured to drain water from the ledge in order to avoid potential water damage to a mobile computing device that is rested on the stand 30. In the embodiments illustrated in FIGS. 2-3, for example, the ledge 31 is angled rearward and the support wall 32 includes an aperture 34 through which water that lands on the ledge, e.g. through precipitation, will naturally flow off of the ledge and onto the ground. Various other configurations are also contemplated without departing from the scope of the present disclosure. For example, the ledge 31 itself may be provided with one or more apertures (which should have dimensions that are smaller than the smallest mobile computing device 100 that may be rested on the ledge) or one or more channels that direct the water off the ledge and, desirably, to the ground surface on which the musical instrument 10 is mounted.

In other, non-illustrated, embodiments, it is contemplated that other mechanisms for holding a mobile computing device such as a smartphone or tablet at the desired position may be utilized in place of a device stand that includes a lower supporting ledge 31 and a device support wall 32. In some embodiments, for instance, a clamping mechanism in which a user inserts the mobile computing device between two opposing clamp members, which are then brought toward one another in order to clamp the mobile computing device in place, is contemplated. For a musical instrument that is configured for public recreational use, however, such a clamping mechanism could pose a variety of drawbacks relative to a stand having a lower supporting ledge and a device support wall of the sort shown and described herein.

The device stand 30 may also include a mounting plate 33. In some embodiments, the mounting plate 33 may be affixed directed to a portion of the musical instrument, e.g. the frame 12 or at least one of the one or more support posts 13. In some embodiments, for instance, the mounting plate 33 may comprise one or more, and optionally a plurality of, apertures 35, each of which is configured to receive a fastener such as a bolt or screw. Where the frame 12 has an adequate surface to receive the mounting plate 33, the mounting plate may be directed secured to that surface of the frame, e.g. by inserting one or more fasteners through the apertures in the mounting plate and into or through corresponding apertures in the frame. In other embodiments, however, the frame 12 may not provide an adequate surface for mounting of the device stand 30. In such embodiments, the device stand 30 may further include a frame extension element 36.

In the embodiment illustrated in FIGS. 2-3, for example, the music stand comprises a frame extension element 36. As shown in FIG. 3, the frame extension element 36 is configured to be affixed to another part of the musical instrument—here a number of the resonators 15, and the mounting plate 33 is configured to be affixed to the frame extension element. The frame extension element 36 extends in a direction away from the plurality of tone-producing elements 11 and thereby provides a surface to which the mounting plate 33 can be attached without interfering with the tone-producing elements. In the illustrated embodiment, the frame extension element 36 is positioned between a number of the tone-producing elements 11 and the resonators 15 associated with each of those tone-producing elements. In other embodiments, the frame extension element 36 may be affixed to a portion of the support structure, such as the frame 12 and/or one or more of the support posts 13.

The frame extension element 36 may comprise a first set of one or more apertures 37, each of which is configured to receive a fastener such as a bolt, screw, or the like, to attach the frame extension element to another portion of the musical instrument, such as the resonators 15, the frame 12, etc., and a second set of one or more apertures 38, each of which is configured to receive a fastener such as a bolt, screw, or the like, by which the mounting plate 33 can be attached to the frame extension element.

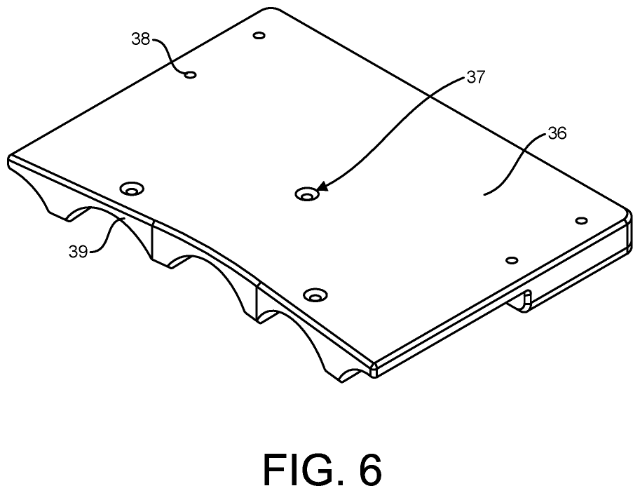

The frame extension element 36 used in the embodiment shown in FIGS. 1-3 is illustrated in FIG. 6. In the illustrated embodiment the frame extension element 36 is secured to the resonators 15 by fasteners that extend through apertures 37, such as is shown in FIG. 3. The mounting plate 33 is secured to the frame extension element 36 by fasteners that extend through apertures 38, such as is also shown in FIG. 3.

As shown in FIG. 6, the frame extension element 36 comprises a generally flat upper surface which provides for a secure and stable coupling with the mounting plate 33. However, the lower surface of the frame extension element 36 comprises a plurality of concave curves 39, each of which is configured to correspond and prevent interference with one of the resonators 15. In some embodiments, the frame extension element 36 may comprise one or more contours 39 that prevent interference between the stand and one or more of the plurality of tone producing elements, one or more resonators, or a combination thereof. These contours 39 may be located on the upper surface of the frame extension element 36, on the bottom surface of the frame extension element, or both, depending on the design of the musical instrument 10 to which the device stand 30 is being attached. Further, though the contours 39 of the illustrated embodiment are concave indents, other shapes and geometries are also contemplated as may be necessary depending on the design of the musical instrument 10.

As an alternative to the frame extension element 36, the mounting plate 33 itself could instead be configured to extend underneath one or more of the tone-producing elements 11 or the like so as to be mounted to another portion, e.g. the frame 12 or a number of resonators 15, of the musical instrument 10 without interfering with the tone-producing elements. When the geometry of the frame 12, tone-producing elements 11, and/or resonators 15 requires a complex solution, however, as in the case of the embodiment shown in FIGS. 1-3, a frame extension element 36 may be preferred.

As described above, in some embodiments the machine-readable code 20 may be a code that is configured to be scanned by the camera of a mobile computing device 100. In the embodiment illustrated in FIGS. 1-3, for example, the machine-readable code 20 is a QR code. In embodiments in which the machine-readable code 20 is a scannable code, the machine-readable code 20 may be affixed to any visible part of the musical instrument 10, including for example the music stand 30, the frame 12, or at least one of the support posts 13. In other embodiments, the machine-readable code 20 may be directly printed and/or etched on any visible part of the musical instrument 10, including for example the music stand 30, the frame 12, or at least one of the support posts 13.

In some embodiments, the machine-readable code may be printed or etched on a metal plate, for example a weather-resistant stainless steel plate. The plate may then be affixed to any visible part of the musical instrument, including for example the music stand, the frame, or at least one of the support posts. The plate may be affixed to the musical instrument using any of a number of different manners, including for instance weather-resistant adhesive or one or more fasteners. In some embodiments, for instance, the metal plate may be affixed to the musical instrument by a plurality of rivets.

In the illustrated embodiment, for example, the machine-readable code 20 is affixed to the music stand 30. More specifically, the machine-readable code 20 is printed on a small metal plate that is adhered to metal plate 40. Metal plate 40 is affixed to the front of the support wall 32 of the device stand 30 through a plurality of rivets. This allows metal plate 40 to be used with a variety of different instruments simply by affixing an appropriate code, e.g., a small plate having a machine-readable code 20 that corresponds with that particular instrument.

In other embodiments, the machine-readable code 20 may be directly printed or etched on metal plate 40, which is affixed to the front of the support wall 32 of the device stand 30 through a plurality of rivets. In alternative embodiments, the machine-readable code 20 may be printed or etched directly on the front face of the support wall 32. In yet other embodiments, the machine-readable code 20 may be printed on a material, e.g. a small plate as shown in the illustrated embodiment or a flexible material having an adhesive backing, and adhered to any exposed surface of the musical instrument, e.g. adhered to the front face of the support wall 32, the frame 12, one of the support posts 13, or the like.

In other (non-illustrated) embodiments, the machine-readable code 20 may be a code that is configured to be read by placing the mobile computing device 100 into proximity with the code, e.g. “tapping”, such as an NFC code. In such an embodiment, the machine-readable code 20 may be attached to the musical instrument at any location where a user could reasonably bring a mobile computing device 100 such as a smartphone into sufficient proximity to read the code. In some embodiments, the machine-readable code 20 may be attached to or incorporated into the device stand 30. For instance, the machine-readable code 20 may be incorporated into a portion of the device stand 30, e.g. the portion of the device stand that makes up the support wall 32, and the front face of the support wall 32 may comprise a visual indication to a user regarding how to use the machine-readable code.

Other types of machine-readable code 20 may be used, the machine-readable code may be attached to the musical instrument 10 in different manners, and the machine-readable code may be attached to the musical instrument in different locations, all without departing from the scope of the present disclosure.

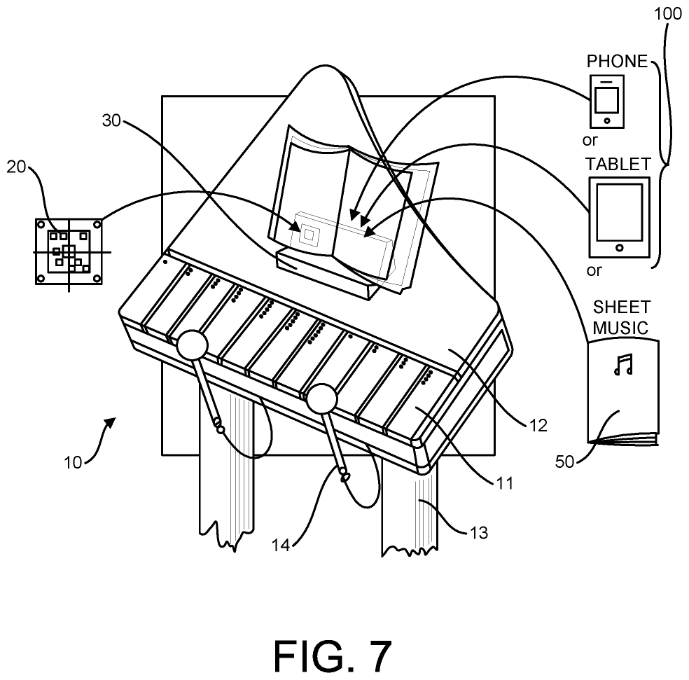

Further, the exact components that make up the device stand 30 and the design of the device stand may be varied without departing from the scope of the present disclosure. For instance, another embodiment of a musical instrument 10 having a device stand 30 configured to support a mobile computing device, including for example a smartphone and a tablet computer, attached thereto is shown in FIG. 7. In the embodiment illustrated in FIG. 7, the frame 12 provides a suitable upper surface for direct attachment of the device stand 30. Accordingly, the device stand 30 having a much more streamlined design may be utilized.

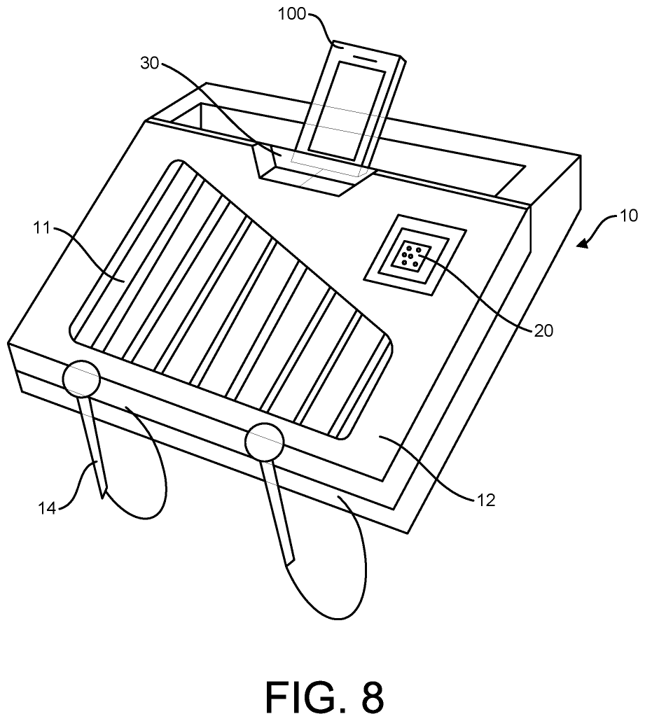

In some embodiments, the device stand 30 may even be incorporated directly into the musical instrument 10, e.g. into the frame 12. An embodiment of such a musical instrument 10 is illustrated in FIG. 8. As shown in FIG. 8, the frame 12 may comprise an integral device stand 30. There, the device stand 30 is defined at least in part by a compartment of the frame 12 that is configured to receive the mobile computing device 100. In other (non-illustrated) embodiments, however, an outward-extending device stand 30, such as that shown in FIG. 7 for example, could be designed and built into the frame 12. It is also noted that the machine-readable code 20 is positioned directly on the frame 12 in the embodiment illustrated in FIG. 8.

It can be seen that the described embodiments provide unique and novel musical instruments 10 that have a number of advantages over those in the art. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A musical instrument configured for use in an outdoor environment, comprising:
a plurality of tone-producing elements, each of which is configured to produce a note having a defined pitch when actuated by a user;
a frame, each of the plurality of tone-producing elements being mounted to the frame;
one or more support posts configured to support the frame at an elevated position relative to a ground surface; and
a machine-readable code, wherein the machine-readable code is configured to be read by a mobile computing device and, when read, to furnish the mobile computing device with one or more interactive functions relating to the musical instrument.

2. The musical instrument of claim 1, further comprising a stand, the stand being configured to support the mobile computing device at a position and angle such that a screen of the mobile computing device is visible to a user while the user actuates the one or more tone-producing elements.

3. The musical instrument of claim 2, wherein the stand is coupled to another portion of the musical instrument.

4. The musical instrument of claim 2, wherein the stand comprises a ledge and a device support wall.

5. The musical instrument of claim 4, wherein at least one of the ledge and the device support wall comprises one or more apertures or channels configured to drain water from the ledge.

6. The musical instrument of claim 4, wherein the stand further comprises a mounting plate that is configured to be affixed to the frame or a frame extension element.

7. The musical instrument of claim 6, the stand further comprising a frame extension element, wherein the frame extension element is configured to be coupled to the frame or one or more resonators, and the mounting plate is configured to be coupled to the frame extension element.

8. The musical instrument of claim 7, wherein the frame extension element comprises one or more contours that prevent interference between the stand and one or more of the plurality of tone producing elements, one or more resonators, or a combination thereof.

9. The musical instrument of claim 2, wherein the stand is configured to support the mobile computing device at an angle of about 65 degrees relative to the ground surface.

10. The musical instrument of claim 2, wherein the machine-readable code is on a front face of the stand.

11. The musical instrument of claim 10, wherein the front face of the stand is defined, at least in part, by a metal plate, and the machine-readable code is either (a) printed or etched on the metal plate or (b) adhered to the metal plate.

12. The musical instrument of claim 1, wherein the one or more interactive functions comprises:
playing one or more musical backing tracks;
providing one or more training features;
providing one or more play challenges;
displaying one or more song sheets;
providing one or more recording features; or
any combination thereof.

13. The musical instrument of claim 1, wherein the machine-readable code is configured so that, when read, a website or application opens on the mobile computing device or a user is prompted by the mobile computing device to open a website or application, the website or application being configured to perform the one or more interactive functions.

14. The musical instrument of claim 1, wherein the machine-readable code is configured to be scanned by a camera element of the mobile computing device.

15. The musical instrument of claim 1, wherein the machine readable code is configured to be read by placing the mobile computing device into proximity with the code.

16. The musical instrument of claim 1, further comprising one or more mallets, each of the one or more mallets being configured for striking one or more of the plurality of tone producing elements, and each of the one or more mallets being attached to the frame or at least one of the one or more support posts by a cable.

17. The musical instrument of claim 1, wherein a lower end of each of the one or more support posts is configured to be mounted to the ground surface in an outdoor environment.

18. The musical instrument of claim 2, wherein the plurality of tone-producing elements, the frame, the machine-readable code, and the stand are configured to withstand the stresses of being in an outdoor environment.

19. The musical instrument of claim 2, further comprising a weather-resistant song book or sheet attached to at least one of the stand, the frame, and at least one of the one or more support posts, and wherein the stand is also configured to support the weather-resistant song book or sheet.

20. A method of operating the musical instrument of claim 1, comprising:
using a mobile computing device to read the machine-readable code that is present on the musical instrument;
selecting an interactive feature using the mobile computing device;
actuating one or more of the of tone-producing elements in response to an output of the mobile computing device.
